(19) United States
(12) Patent Application Publication
(10) Pub. No.: US 2023/0274132 A1
(43) Pub. Date: Aug. 31, 2023

(54) METHODS AND APPARATUS TO DYNAMICALLY NORMALIZE DATA IN NEURAL NETWORKS

(71) Applicant: Intel Corporation, Santa Clara, CA (US)

(72) Inventors: Dongqi Cai, Beijing (CN); Anbang Yao, Beijing (CN); Yurong Chen, Beijing (CN)

(21) Appl. No.: 18/005,804

(22) PCT Filed: Aug. 26, 2020
(86) PCT No.: PCT/CN2020/111272

§ 371 Date: Jan. 17, 2023

(51) Int. Cl. G06N 3/08

(52) U.S. Cl. CPC G06N 3/08

(57) ABSTRACT

Methods, apparatus, systems, and articles of manufacture to dynamically normalize data in neural networks are disclosed. An apparatus for use with a machine learning model includes at least one normalization calculator to generate a plurality of alternate normalized outputs associated with input data for the machine learning model. Different ones of the alternate normalized outputs based on different normalization techniques. The apparatus further includes a soft weighting engine to generate a plurality of soft weights based on the input data. The apparatus also includes a normalized output generator to generate a final normalized output based on the plurality of alternate normalized outputs and the plurality of soft weights.

### FIELD OF THE DISCLOSURE

This disclosure relates generally to neural networks, and, more particularly, to methods and apparatus to dynamically normalize data in neural networks.

### BACKGROUND

Neural networks and other types of machine learning models are useful tools that have demonstrated their value solving complex problems regarding pattern recognition, natural language processing, automatic speech recognition, etc. Neural networks operate using artificial neurons arranged into one or more layers that process data from an input layer to an output layer, applying weighting values to the data during the processing of the data. Such weighting values are typically determined during a training process.

### BRIEF DESCRIPTION OF THE DRAWINGS

FIG. 1 is a diagram of an example convolutional layer of an example convolutional neural network (CNN).

FIG. 2 is an example dynamic soft normalization (DSN) process flow for the normalization operation of FIG. 1.

FIG. 3 illustrates an example soft weighting process flow for implementing the soft weight generation process of FIG. 2.

FIG. 4 is a block diagram of an example computing system that may be used to train and/or execute a machine learning model (e.g., a neural network) design in accordance with teachings disclosed herein.

FIG. 5 is a block diagram illustrating an example implementation of the example DNS engine of FIG. 4.

FIG. 6 is a flowchart representative of machine readable instructions which may be executed to implement the example computing system of FIG. 4.

FIG. 7 is a flowchart representative of machine readable instructions which may be executed to implement the example DSN engine of FIGS. 4 and 5.

FIG. 8 is a block diagram of an example processing platform structured to execute the instructions of FIG. 3 to implement the computing system of FIG. 4 and the associated DSN engine of FIGS. 4 and 5.

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. One particular type of machine learning model is a neural network. In general, machine learning models/architectures that are suitable to use in the example approaches disclosed herein will be any type of neural network (e.g., a recurrent neural network (RNN), a convolutional neural network (CNN), a deep neural network (DNN), etc.) that involves the normalization of data being analyzed at one or more of the layers in the network.

Normalization plays an important role in both the training of deep neural networks and the implementation of deep neural networks to make inferences about input data. Frequently, normalization involves the standardization of the data being analyzed by re-centering (e.g., zero-centering) the data and by re-scaling and/or shifting data using statistics (e.g., mean and standard deviation) calculated from a running subset of the data. More particularly, in some examples, the calculated statistics are used to standardize the input data to have a mean of 0 and a standard deviation of 1. This normalization process is usually implemented at each layer in a neural network. Thus, the data being re-centered and re-scaled corresponds to either the original input data to the neural network (for the input layer) or the output data of a previous layer in the neural network (for every subsequent layer). The component(s) of a neural network that perform normalization are sometimes referred to as normalizers and may be implemented via software, firmware, and/or hardware.

Many known normalization techniques estimate the statistics (e.g., mean and standard deviation) used to standardize or normalize input data at each layer in a neural network during training across a certain subset of the training data. Such estimated statistics are then defined as internal parameters of the neural network that are used during the inference stage associated with the analysis of new and different input data (e.g., other than the training data). However, different input samples (e.g., the underlying data to be analyzed), for training and/or inference, carry distinctive features for which different statistics may be appropriate to standardize the data for improved performance (e.g., more accurate inferences). However, existing normalization techniques are unable to adjust the statistics based on the particular features of a current input sample being analyzed because the statistics are defined as internal parameters of the machine learning model without regard to the particular input data being analyzed. By contrast, examples disclosed herein enable a normalizer to dynamically adjust the estimated statistics for normalization developed during training in a manner that is conditioned on and/or in response to particular features of the particular input data being analyzed. In other words, the normalization process disclosed herein is sample aware and is able to dynamically adapt to different features of different samples. As a result, examples disclosed herein achieve greater accuracy than is possible using existing normalization techniques that are premised on fixed internal model parameters developed during training independent of the particular input data under analysis.

Many different normalization techniques have been developed in the past including batch normalization (BN), instance normalization (IN), layer normalization (LN), group normalization (GN), batch-instance normalization (BIN), and switchable normalization (SN). Such techniques each have different applications, advantages, and drawbacks. For example, BN techniques standardize the data using statistics estimated batch-wise (e.g., the mean and standard deviation are calculated across different batches in a subset (e.g., a mini-batch) of the available training dataset). BN techniques are sensitive to the size of (e.g., number of batches in) the training data. Thus, while BN techniques are relatively accurate for a large number of batches in the training dataset, such techniques becomes less reliable when the number of batches is relatively small. IN techniques standardize the data using statistics estimated channel-wise (e.g., the mean and standard deviation are calculated across different channels in the mini-batch). IN techniques have been found to be well suited for recurrent neural network (RNN) models and have been successfully implemented in image stylization tasks. LN techniques standardize the data using statistics estimated layer-wise (e.g., the mean and standard deviation are calculated across different features in the mini-batch). GN techniques divide the channels into groups and estimate the statistics for standardization of data within each group, thereby alleviating the sensitivity to batch size. However, GN techniques are sensitive to the number of groups, which is defined as a hyperparameter for the neural network. Both BIN and SN techniques involve the combination of different normalization techniques. More particularly, BIN techniques adaptively adjust (e.g., through weight averaging) a combination of both the BN techniques (e.g., batch-wise estimated statistics) and the IN techniques (e.g., channel-wise estimated statistics). SN techniques adaptively adjust (e.g., through weight averaging) a combination of BN techniques, IN techniques, and LN techniques.

Each of the above normalization techniques has particular advantages that make the particular technique suitable for certain applications. However, each also presents certain limitations and/or disadvantages. Among other things, as already noted above, existing normalization techniques are not able to dynamically adjust or calculate statistics for data standardization based on the particular input data being analyzed but are limited to fixed internal parameters generated during training based on the relevant subset of the input data used for the particular normalization technique employed. Further, existing normalizers typically implement a single normalization technique that is applied at every layer in a neural network such that the different types of normalization methodologies cannot be taken advantage of when appropriate for different layers within a single network architecture. While the BIN and SN techniques do involve the combination of different techniques, the weight averaging of the different techniques is not dynamically based on the sample input data being analyzed but still depend on fixed internal model parameters among summed input dimensions developed during model training.

Furthermore, different normalizers are typically designed to perform different tasks (e.g., object detection, image classification, video recognition, speech recognition, image stylization, etc.) such that model designs that involve multiple tasks can be cumbersome. Further still, the generally specific applications or tasks to which normalizers are designed limits the ability of a neural network to be adapted or reworked for other tasks not originally contemplated when initially developing the neural network. Examples disclosed herein overcome these disadvantages by providing a generally applicable normalization engine that can readily adapt to different tasks while maintaining relatively high performance (e.g., producing relatively accurate outputs) by adjusting the normalization process based on the particular input data being analyzed.

More specifically, example normalization engines disclosed herein include a set of multiple different normalizers to implement different normalization techniques. Example normalization engines also include a soft weighting engine to dynamically generate weights indicative of the contribution of the outputs of the multiple different normalizers. In some examples, the different normalization techniques implemented by the example normalization engines may correspond to any past, present, or future normalization techniques, thereby enabling the normalization engine to adapt to different tasks and/or circumstances. That is, example normalization engines disclosed herein implement multiple different normalizers that use different normalization techniques to redistribute input samples from different aspects, thereby enriching the representation of the input features. This can lead to improved accuracy in the output of neural network models over existing methodologies that rely on a single normalization technique. Further, in some examples, the weights generated by the soft weighting engine are calculated based on the sample data specific to the underlying input data under analysis, thereby enabling the normalization process to dynamically adjust in response to distinctive features that may appear in the data.

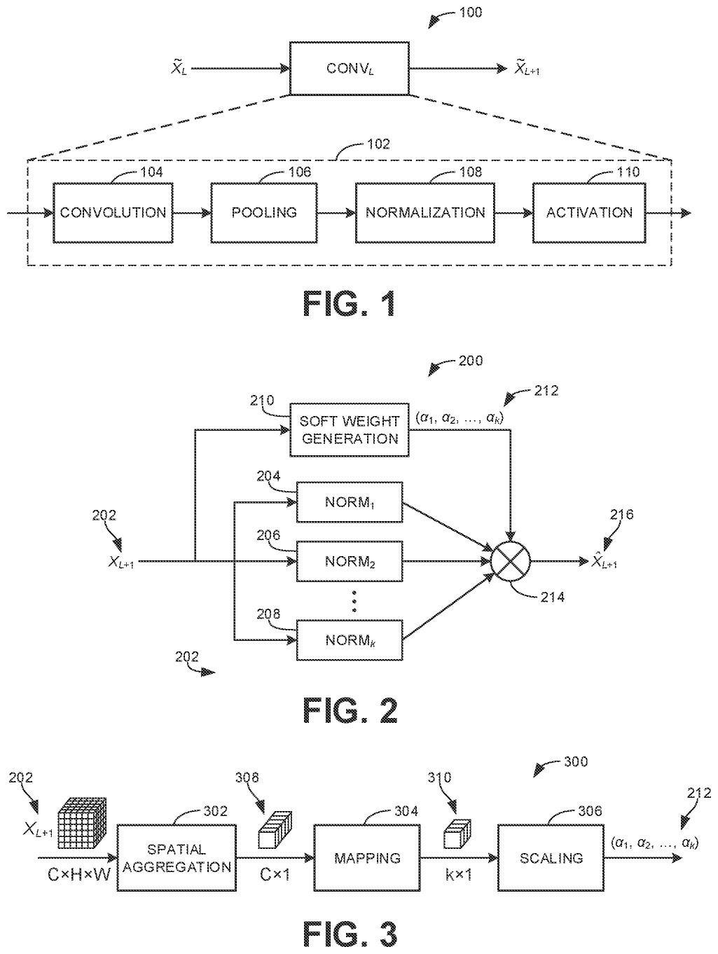

FIG. 1 is a diagram of an example convolutional layer 100 of an example convolutional neural network (CNN) that follows a general operational flow 102. For purposes of explanation, it is assumed that the CNN is being implemented to perform tasks associated with image analysis (e.g., image classification). However, the neural network may be used to perform any other suitable task. Furthermore, examples disclosed herein may be implemented in connection with any other suitable type of neural network other than a CNN (e.g., any deep neural network (DNN)).

As represented in FIG. 1, the general operational flow 102 for the convolutional layer 100 includes a convolution operation 104, a pooling operation 106, a normalization operation 108, and an activation operation 110. In this example, the convolution operation 104 involves applying a filter (e.g., a kernel) to one or more input images to generate an output feature map. The pooling operation 106 involves reducing the dimensions of the data (e.g., spatially reducing the size of input image(s) and/or associated feature maps being analyzed). The normalization operation 108, as described above, involves standardizing the input data (e.g., as output by the pooling operation 106) using statistics, such as mean and standard deviation, calculated based on a certain subset of the input data. The activation operation 110 involves applying an activation function (typically a nonlinear function such as a rectified linear unit (ReLU) function) to the normalized data output by the normalization operation 108 to generate a final output.

In the illustrated example of FIG. 1, each of the convolution operation 104, the pooling operation 106, and the activation operation 110 may be implemented in any suitable manner (e.g., consistent with the operation of typical CNNs). However, the normalization operation 108 is implemented in accordance with teachings disclosed herein. More particularly, FIG. 2 is an example dynamic soft normalization (DSN) process flow 200 for the normalization operation 108 of FIG. 1. For purposes of explanation and consistency with the description of FIG. 1, the example DSN process flow 200 is described herein in the context of a CNN. However, the DSN process flow 200 may be implemented to perform normalization in connection with any suitable type of neural network.

As shown in the illustrated example of FIG. 2, the example DSN process flow 200 involves analyzing input data 202 using a plurality of different normalization techniques 204, 206, 208. In this example, the input data 202 corresponds to the feature map output by the pooling operation 106 of FIG. 1. While FIG. 2 shows three different normalization techniques 204, 206, 208, in some examples, only two normalization techniques may be used. In other examples, more than three normalization techniques may be used.

In some examples, each of the normalization techniques 204, 206, 208 corresponds to a different normalization technique. The particular normalization techniques implemented may be any suitable past, present, or future technique. For example, the first normalization technique 204 may correspond to batch normalization (BN), the second normalization technique 206 may correspond to instance normalization (IN), and the third normalization technique 208 may correspond to layer normalization (LN). As described above, these different normalization techniques have different advantages that are suitable to different circumstances (e.g., different deep learning tasks and/or different network architectures). As such, having a variety of different normalization techniques that implement different normalization techniques enable a system implementing the example DSN process flow 200 of FIG. 2 to readily adapt to different circumstances (e.g., different tasks, applications, and/or network architectures). Furthermore, experimental testing has shown that combining the outputs of the different normalization techniques 204, 206, 208 provides a performance boost (e.g., increased accuracy) when training general deep neural networks relative to a neural network that normalize data based on a single normalization technique.

Stated generally, each of the normalization techniques 204, 206, 208 are implemented to estimate statistics, such as the mean and variance (e.g., standard deviation) of the underlying data (e.g., the input data 202). The normalization techniques 204, 206, 208 differ based on the particular subset of the data (e.g., particular pixels of one or more sample images/input data) used to calculate the relevant estimated statistics. The normalized output of the different normalization techniques 204, 206, 208 may be generically represented mathematically as

$${Norm}_{k} ( {X}_{L + 1} ; {θ}_{k} ) = \frac{{X}_{L + 1} - {μ}_{k}}{\sqrt{{σ}_{k}^{2} + ϵ}} * {γ}_{k} + {β}_{k} \qquad Eq . 1$$

where γₖ and βₖ are respective scale and shift parameters of the k^{th} normalization technique, ϵ is a small constant to preserve numerical stability, and μₖ and σₖ are the respective mean and standard deviation estimated using a particular set of input pixels as defined by the k^{th} normalization technique.

As mentioned above, there are some known normalization techniques that already involve the combination of two or more other known normalization techniques (e.g., BIN and SN techniques). These techniques may also be used for one or more of the normalization techniques 204, 206, 208 shown in FIG. 2. While such techniques involve the combination of other different normalization techniques, examples disclosed herein differ from such techniques in the way that the outputs of the different normalization techniques are combined. More particularly, as shown in FIG. 2, in addition to processing the input data 202 with each of the different normalization techniques 204, 206, 208, the input data 202 is also analyzed in a soft weight generation process 210 to generate a plurality of soft weights 212. The number of soft weights 212 generated through the soft weight generation process 210 corresponds to the number of normalization techniques 204, 206, 208 represented in the example DSN process flow 200. More particular, in some examples, each one of the soft weights 212 is associated with a corresponding normalization technique 204, 206, 208 and defines the contribution of the corresponding normalization technique 204, 206, 208 to a final normalized output. That is, the output of each normalization technique 204, 206, 208 corresponds to one of multiple different alternate normalized outputs for the input data, each of which is to be used in calculating a final normalized output. Specifically, each alternate normalized output (generated by each different normalization technique 204, 206, 208) is multiplied by its respective soft weight 212 and then the outcomes are summed in a sum-of-products operation 214 to produce a final normalized output 216 of the DSN process flow 200. This calculation may be expressed mathematically as

$${\hat{X}}_{L + 1} = {\sum }_{k} {α}_{k} * {Norm}_{k} ( {θ}_{k} ) = {\sum }_{k} {α}_{k} * ( \frac{{X}_{L + 1} - {μ}_{k}}{\sqrt{{σ}_{k}^{2} + {ϵ}_{k}}} * {γ}_{k} + {β}_{k} ) \qquad Eq . 2$$

where αₖ is the k^{th} soft weight 212 and Normₖ is the k^{th} normalization technique 204, 206, 208. The final normalized output 216 corresponds to the output of the normalization operation 108 of FIG. 1 and the resulting input to the activation operation 110 of FIG. 1.

As used herein, the term “soft,” used in the context of “soft weights,” means that the weights are given a value on a continuous scale rather than being defined as one of different discrete values. For instance, in some examples, the soft weights may be calculated to have any value from 0 to 1 (rather than “hard” weights, which may be limited to either a value of 0 or a value of 1). The soft weights need not be limited to a scale or range from 0 to 1 but may be assigned any suitable values (e.g., negative values, values greater than 1, etc.).

As represented in FIG. 2, the soft weights 212 are calculated based on the input data 202 independent of the normalization techniques 204, 206, 208 (that separately process the input data 202). As a result, the particular contribution of each of the normalization techniques 204, 206, 208, as defined by the corresponding soft weight 212 is determined based on the particular sample input data being analyzed by the associated neural network. In other words, the example DSN process flow 200 of FIG. 2 provides a sample-aware normalization process that dynamically adjusts or adapts the final normalized output 216 of the normalization operation based on the input data 202. That is, each iteration through the normalization operation 108 (represented by the example process flow 200 of FIG. 2) for different input samples will result in a different final normalized output 216 because different soft weights 212 will be calculated in response to distinctive features in the different input samples.

FIG. 3 illustrates an example soft weighting process flow 300 for implementing the soft weight generation process 210 of FIG. 2. As shown in the illustrated example, the soft weighting process flow 300 includes three general operations including a spatial aggregation operation 302, a mapping operation 304, and a scaling operation 306. In this example, the size of the input sample (e.g., the input data 202) is defined as the number of channels times the height of the sample (e.g., input image, intermediate feature map, etc.) times the width of the sample (e.g., C×H×W). As mentioned above, the input data corresponding to images to be analyzed by a CNN is for purposes of explanation only and any type of input data may be used. Thus, in other examples, the dimensions of the input data may be defined differently depending on the nature of the input data (e.g., based on the dimensions of a tensor representing the data). As represented in the example of FIG. 2, the spatial aggregation operation 302 reduces the input data in the height and width directions to produce a C-dimensional feature vector 308 (e.g., C×1). In some examples, the spatial aggregation operation 302 is implemented as a spatial average pooling with a kernel size of H×W. However, other spatial aggregation algorithms may alternatively be used (e.g., max pooling).

The mapping operation 304 involves mapping the C-dimensional feature vector 308 either linearly or non-linearly to a k-dimensional vector 310, where k is the number of normalization techniques 204, 206, 208 implemented in the example DSN process flow 200 of FIG. 2. In some examples, the mapping operation 304 is implemented as a fully connected network layer with k output units.

Finally, the scaling operation 306 involves scaling the values in the k-dimensional vector 310 to k-dimensional soft weights 212. In some examples, the soft weights are scaled such that all of the soft weights sum to 1 (e.g., Σₖαₖ=1). In some examples, this scaling operation 306 is implemented with a softmax layer that uses the softmax function to map the input vector (e.g., the k-dimensional vector 310) to the output soft weights 212. In other examples, the soft weights may be scaled in any other suitable manner. In some examples, scaling may be omitted such that the values of the elements in the k-dimensional vector 310 define the soft weights 212.

As noted above, the soft weights 212 are calculated based on the input data 202 and applied to respective ones of the alternate normalized outputs of the normalization techniques 204, 206, 208 to calculate the final normalized output 216. Thus, unlike existing normalization methodologies that use or share fixed internal normalization parameters across different samples, the final normalized output 216 of the illustrated example is dynamically adjusted based on different contributions of different normalization techniques 204, 206, 208 as determined by the discrimination of the specific input sample(s) that are to be normalized. Furthermore, in addition to the soft weights 212 (and, thus, the final normalized output 216) varying from sample to sample, the ability of the soft weights 212 to define different contributions of the different underlying normalization techniques 204, 206, 208 enable the overall DSN process flow 200 to adapt in different normalization layers for different network architectures and/or to adapt to different deep learning tasks.

The implementation of multiple different normalization techniques 204, 206, 208, as well as the soft weight generation process 210 result in an increase of compute operations for an associated neural network. However, the extra compute operations amount to a relatively small proportion of all operations performed in connection with the implementation of a full neural network. That is, the memory and/or computational costs of many existing normalizers like BN and its variants are very small compared with of full neural network model such that implementing several different normalizers will not have a significant impact. For example, given a 3×3 convolutional layer with an input feature map having a size denoted by W×H×Cᵢₙ (where Cᵢₙ is frequently 128, 256, 512, 1024, or 2048, but may be larger) and an output feature map with a size denoted by W×H×Cₒᵤₜ (where Cₒᵤₜ is frequently one or two times that of Cᵢₙ), the number of convolutional parameters is equal to 3×3×CᵢₙCₒᵤₜ and the number of floating point operations (FLOPs) (e.g., multiply-add operations) is W×H×3×3×Cᵢₙ×Cₒᵤₜ Relative to this total number of convolutional parameters, the parameter size for BN is only 4×Cₒᵤₜ, which corresponds to 4/(3×3×Cᵢₙ) of the total number of parameters for the entire convolutional layer (e.g., approximately 0.26% of the total when Cᵢₙ is 128 and a much smaller percentage as Cᵢₙ increases). Further, the number of FLOPs for BN is 2×Cₒᵤₜ×W×H, which is only 2/(3×3×Cᵢₙ) of the total number of FLOPs (e.g., approximately 0.13% of the total when Cᵢₙ is 128 and a much smaller percentage as Cᵢₙ increases). Many other known normalization techniques (e.g., LN, IN, GN, etc.) have similar memory and/or computational costs to that of BN. Thus, even if multiple different normalization techniques are implemented, as disclosed herein, the combined size of the parameters for all of the different techniques would remain a relatively small percentage of the total size of the neural network.

The memory and/or computational cost of the soft weight generation process to dynamically determine the contribution of each of the different normalization techniques is also relatively small when compared with the entire model. In particular, with reference to FIG. 3, it can be seen that the additional parameter size due to the soft weighting process flow 300 is k×Cᵢₙ, which corresponds to k/(3×3×Cₒᵤₜ) of the total number of parameters for the entire convolutional layer. In some examples, k (the number of different normalization techniques) is expected to be 3 or 4 (but could be lower or higher). With k being 4 and Cₒᵤₜ being twice that of Cᵢₙ, the soft weight generation process corresponds to approximately 0.17% of the total number of parameters for the entire model (and becomes an even smaller percentage as Cᵢₙ increases). Thus, examples disclosed herein have a relatively negligible impact on memory and computational costs relative to a full neural network model (e.g., less than 0.5% to ResNet-50).

The relatively minor increase in computational operations becomes insignificant in view of the versatility of neural networks constructed with a normalization process flow as detailed in FIGS. 2 and 3. In particular, example neural networks disclosed herein can be readily used in any type of deep neural network (from relatively small networks to relatively large and complex ones). Furthermore, example neural networks disclosed herein may be adapted to any type of deep learning task, thereby making such networks far more generally applicable that existing solutions.

Additionally, calculating soft weights 212 based on input samples to determine the appropriate combination of the underlying normalization techniques 204, 206, 208 that contribute to the final normalized output 216 has been shown to provide a significant performance boost (e.g., increased accuracy) relative to other known normalization methodologies. Thus, the relatively small increase in computational costs is more than offset by the improvement to the accuracy of example neural networks that implement teachings disclosed herein.

More particular, during experimental testing, an example DSN engine to implement the example DSN process flow 200 of FIG. 2 was constructed with four normalizers implementing four different normalization techniques corresponding to BN, IN, LN, and GN. The example normalization engine was first verified by implementing a large-scale image classification task using the ImageNet dataset. Experimentation was performed using both ResNet-18 and ResNet-50 as the backbone for the neural network models with all four normalizers replaced with the example normalization engine disclosed herein. All models were trained for 90 epochs with an initial learning rate of 0.1 that was decreased by 10× after 30 and 60 epochs. The batch size was 256. Based on these parameters, it was found that that the DSN engine outperformed each of the underlying normalization techniques when used individually. Comparisons of single-crop (224×224) validation error rates are summarized in Table 1. As demonstrated in Table 1, the DSN engine was found to provide a significant boost in performance relative to all other normalization techniques to which it was compared.

TABLE 1
Comparison validation errors (%) on ImageNet dataset

| Backbone | Method | Top-1 | Top-5 |
|---|---|---|---|
| ResNet18 | BN | 30.046 | 10.752 |
| | DSN | 27.416 | 9.732 |
| ResNet50 | Plain* | 31.48 | 12.27 |
| | IN | 28.4 | |
| | LN | 25.3 | |
| | GN | 24.1 | |
| | BN | 23.990 | 7.166 |
| | DSN | 21.53 | 6.206 |

*The Plain method indicates no normalization is used

Further experimental testing was performed by implementing a large-scale video classification task using the Kinetics dataset on a ResNet-50 I3D backbone. The models were all pre-trained using the ImageNet dataset. The top-1 and top-5 classification accuracies on the validation set are shown in Table 2 based on a standard 10-clip testing that averages softmax scores from 10 clips that are evenly sampled. Similar to the image classification task (summarized in Table 1), as shown in Table 2, the example DSN engine outperforms both BN and GN based networks with stable margins under all three settings for a video recognition task.

TABLE 2
Video classification in Kinetics: ResNet-50
I3D's top-⅕ accuracy (%)

| | | | |
|---|---|---|---|
| clip length | 32 | 32 | 64 |
| batch size | 8 | 4 | 4 |
| BN [4] | 73.3/90.7 | 72.1/90.0 | 73.3/90.8 |
| GN [4] | 73.0/90.6 | 72.8/90.6 | 74.5/91.7 |
| DSN | 74.7/91.4 | 73.6/91.0 | 75.2/92.2 |

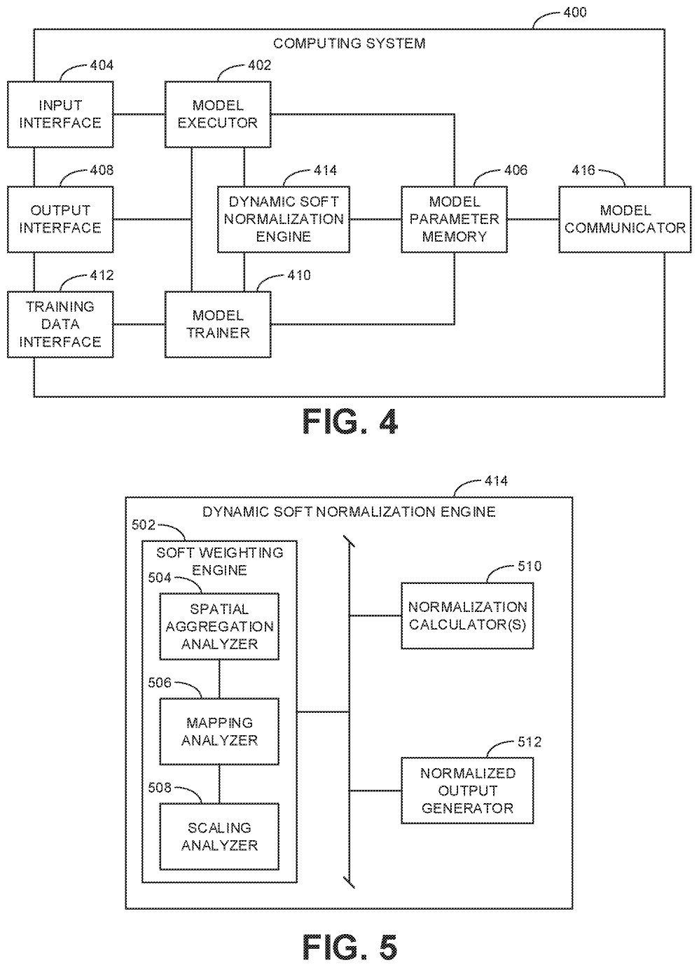

FIG. 4 is a block diagram of an example computing system 400 that may be used to train and/or execute a machine learning model (e.g., a neural network) design in accordance with teachings disclosed herein. The example computing system 400 includes a model executor 402 that accesses input values via an input interface 404, and processes those input values based on a machine learning model stored in a model parameter memory 406 to produce output values to be transmitted via an output interface 408. In the illustrated example of FIG. 4, example neural network parameters stored in the model parameter memory 406 are trained by an example model trainer 410 such that input training data received via a training data interface 412 results in output values based on the training data. In the illustrated example of FIG. 4, the model executor 402 utilizes a dynamic soft normalization (DSN) engine 414 when processing the model during training and/or inference.

The example computing system 400 may be implemented as a component of another system such as, for example, a mobile device, a wearable device, a laptop computer, a tablet, a desktop computer, a server, etc. In some examples, the input and/or output data is received via inputs and/or outputs of the system of which the computing system 400 is a component.

In some examples, the example model executor 402, the example model trainer 410, and the example DSN engine 414 are implemented by one or more logic circuits such as, for example, hardware processors. In some examples, one or more of the example model executor 402, the example model trainer 410, or the example DSN engine 414 are implemented by a same hardware component (e.g., a same logic circuit). However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc.

In examples disclosed herein, the example model executor 402 executes a machine learning model. The example machine learning model may be implemented using a neural network (e.g., a deep neural network). However, any other past, present, and/or future machine learning topology(ies) and/or architecture(s) may additionally or alternatively be used.

To execute a model, the example model executor 402 accesses input data via the input interface 404. In some examples, the example model executor 402 (using the example DSN engine 414) applies the model (defined by the internal model parameters stored in the model parameter memory 406) to the input data. The model executor 402 provides the result to the output interface 408 for further use.

The example input interface 404 of the illustrated example of FIG. 4 receives input data that is to be processed by the example model executor 402. In examples disclosed herein, the example input interface 404 receives data from one or more data sources (e.g., via one or more sensors, via a network interface, etc.). However, the input data may be received in any fashion such as, for example, from an external device (e.g., via a wired and/or wireless communication channel). In some examples, multiple different types of inputs may be received.

The example model parameter memory 406 of the illustrated example of FIG. 4 is implemented by any memory, storage device and/or storage disc for storing data such as, for example, flash memory, magnetic media, optical media, etc. Furthermore, the data stored in the example model parameter memory 406 may be in any data format such as, for example, binary data, comma delimited data, tab delimited data, structured query language (SQL) structures, etc. While in the illustrated example the model parameter memory 406 is illustrated as a single element, the model parameter memory 406 and/or any other data storage elements described herein may be implemented by any number and/or type(s) of memories. In the illustrated example of FIG. 4, the example model parameter memory 406 stores internal model parameters that are used by the model executor 402 to process inputs for generation of one or more outputs. Significantly, the internal model parameters stored in the example model parameter memory 406 do not correspond to the soft weights disclosed herein because, as discussed above, the soft weights are dynamically determined based on the current input data under analysis and, therefore, not fixed values to be stored in the model parameter memory 406. Rather, the internal model parameters stored in the example model parameter memory 406 include fixed weights and/or other parameters used to process inputs to generate outputs. For example, the internal model parameters stored in the memory 406 may include the calculated statistics determined by individual ones of the normalization techniques 204, 206, 208 during training that are implemented as part of the example DSN process flow 200 of FIG. 2.

The example output interface 408 of the illustrated example of FIG. 4 outputs results of the processing performed by the model executor 402. In some examples, the nature of the information output by the example output interface 408 depends upon the task to which the example model executor 402 is applying the model defined by the internal parameters stored in the model parameter memory 406. In some examples, the example output interface 408 displays the output values. Additionally or alternatively, in some examples, the output interface 408 provides the output values to another system (e.g., another circuit, an external system, a program executed by the computing system 400, etc.) for display and/or further processing. In some examples, the output interface 408 may cause the output values to be stored in a memory.

The example model trainer 410 of the illustrated example of FIG. 4 compares expected outputs received via the training data interface 412 to outputs produced by the example model executor 402 to determine an amount of training error, and updates the model based on the amount of error. After a training iteration, the amount of error is evaluated by the model trainer 410 to determine whether to continue training. In some examples, errors are identified when the input data does not result in an expected output. That is, error is represented as a number of incorrect outputs given inputs with expected outputs. However, any other approach to representing error may additionally or alternatively be used such as, for example, a percentage of input data points that resulted in an error.

The example model trainer 410 determines whether the training error is less than a training error threshold. If the training error is less than the training error threshold, then the model has been trained such that it results in a sufficiently low amount of error, and no further training is needed. The particular value for the training error depends on the particular task for which the model is being implemented. In some examples, other types of factors (e.g., other than a training error) may be considered when determining whether model training is complete. For example, an amount of training iterations performed and/or an amount of time elapsed during the training process may be considered.

The example training data interface 412 of the illustrated example of FIG. 4 accesses training data that includes example inputs (corresponding to the input data expected to be received via the example input interface 404), as well as expected output data. In examples disclosed herein, the example training data interface 412 provides the training data to the model trainer 410 to enable the model trainer 410 to determine an amount of training error.

The example model communicator 416 of the illustrated example of FIG. 4 enables communication of the model stored in the model parameter memory 406 with other computing systems. In this manner, a central computing system (e.g., a server computer system) can perform training of the model and distribute the model to edge devices for utilization (e.g., for performing inference operations using the model). In examples disclosed herein, the model communicator is implemented using an Ethernet network communicator. However, any other past, present, and/or future type(s) of communication technologies may additionally or alternatively be used to communicate a model to a separate computing system.

The example DSN engine 414 of the illustrated example generates a final normalized output based on input data using multiple different normalization techniques. In some examples, the DSN engine 414 may be implemented in connection with different layers in a neural network. Thus, the input data may correspond to the input data received at the input interface and/or correspond to an output of a previous layer in the neural network (e.g., one or more feature maps). Further detail regarding the implementation of the example DSN engine is shown in connection with FIG. 5.

FIG. 5 is a block diagram illustrating an example implementation of the example DSN engine 414 of FIG. 4. As shown in the illustrated example of FIG. 5, the DSN engine 414 includes an example soft weighting engine 502 to implement the soft weight generation operation 210 described above in connection with the DSN process flow 200 of FIG. 2 and further detailed in the soft weighting process flow 300 of FIG. 3. More particularly, the example soft weighting engine 502 includes an example spatial aggregation analyzer 504 that aggregates the input data to reduce the data to a vector (e.g., the C-dimensional feature vector 308 of FIG. 3). The example spatial aggregation analyzer 504 may reduce the data using any suitable data aggregation algorithm (e.g., max pooling, average pooling, etc.). In the illustrated example, the soft weighting engine 502 includes an example mapping analyzer 506 to map the vector output by the spatial aggregation analyzer 504 to a k-dimensional vector (e.g., the k-dimensional vector 310 of FIG. 3) based on any suitable relationship (e.g., linear, non-linear, etc.). As explained above, the value of k corresponds to the number of different normalization techniques 204, 206, 208 implemented by the DSN engine 414. As shown in FIG. 5, the example soft weighting engine 502 includes a scaling analyzer 508 to scale the values in the k-dimensional vector output by the example mapping analyzer 506 to final values corresponding to the soft weights 212.

In the illustrated example, the DSN engine 414 includes one or more example normalization calculators 510 to calculate alternate normalized outputs based on the input data using different normalization techniques (e.g., the normalization techniques 204, 206, 208 represented in FIG. 2). That is, the example normalization calculator(s) 510 calculate statistics for the input data, such as the mean and standard deviation, and use the calculated statistics to standardize the data by zero-centering and re-scaling the data. The different normalization techniques employed define different subsets of the input data that are used to calculate the statistics and, therefore, standardize or normalize the input data in different ways. That is, each of the multiple different normalization techniques are implemented to generate alternate normalized outputs for the input data. Any past, present, or future normalization techniques may be implemented by the normalization calculator(s) 510. In some examples, a single normalization calculator 510 may implement the operations associated with multiple different normalization techniques. In other examples, there may be distinct normalization calculators 510 that implement distinct normalization techniques.

As shown in the illustrated example of FIG. 5, the DSN engine 414 includes an example normalized output generator 512 to generate a final normalized output based on the soft weights 212 generated by the soft weighting engine 502 and the alternate normalized outputs generated by the normalization calculator(s) 510. More particularly, different ones of the soft weights 212 define the contribution of corresponding ones of the alternate normalized outputs to the final output. Thus, the example normalized output generator 512 generates the final normalized output by multiplying the soft weights 212 with respective ones of the alternate normalized outputs and then summing the products, as set forth in Equation 2.

While an example manner of implementing the computing system 400 is illustrated in FIG. 4 with a detailed example of the DSN engine 414 illustrated in FIG. 5, one or more of the elements, processes and/or devices illustrated in FIGS. 4 and 5 may be combined, divided, re-arranged, omitted, eliminated and/or implemented in any other way. Further, the example model executor 402, the example input interface 404, the example model parameter memory 406, the example output interface 408, the example model trainer 410, the example training data interface 412, the example DSN engine 414, the example model communicator 416, the example soft weighting engine 502, the example spatial aggregation analyzer 504, the example mapping analyzer 506, the example scaling analyzer 508, the example normalization calculator(s) 510, the example normalized output generator 512, and/or, more generally, the example computing system 400 of FIGS. 4 and 5 may be implemented by hardware, software, firmware and/or any combination of hardware, software and/or firmware. Thus, for example, any of the example model executor 402, the example input interface 404, the example model parameter memory 406, the example output interface 408, the example model trainer 410, the example training data interface 412, the example DSN engine 414, the example model communicator 416, the example soft weighting engine 502, the example spatial aggregation analyzer 504, the example mapping analyzer 506, the example scaling analyzer 508, the example normalization calculator(s) 510, the example normalized output generator 512 and/or, more generally, the example computing system 400 could be implemented by one or more analog or digital circuit(s), logic circuits, programmable processor(s), programmable controller(s), graphics processing unit(s) (GPU(s)), digital signal processor(s) (DSP(s)), vision processing unit(s) (VPU(s)), AI-specific processor(s) (e.g., a hardware accelerator), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example model executor 402, the example input interface 404, the example model parameter memory 406, the example output interface 408, the example model trainer 410, the example training data interface 412, the example DSN engine 414, the example model communicator 416, the example soft weighting engine 502, the example spatial aggregation analyzer 504, the example mapping analyzer 506, the example scaling analyzer 508, the example normalization calculator(s) 510, and/or the example normalized output generator 512 is/are hereby expressly defined to include a non-transitory computer readable storage device or storage disk such as a memory, a digital versatile disk (DVD), a compact disk (CD), a Blu-ray disk, etc. including the software and/or firmware. Further still, the example computing system 400 may include one or more elements, processes and/or devices in addition to, or instead of, those illustrated in FIGS. 4 and 5, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

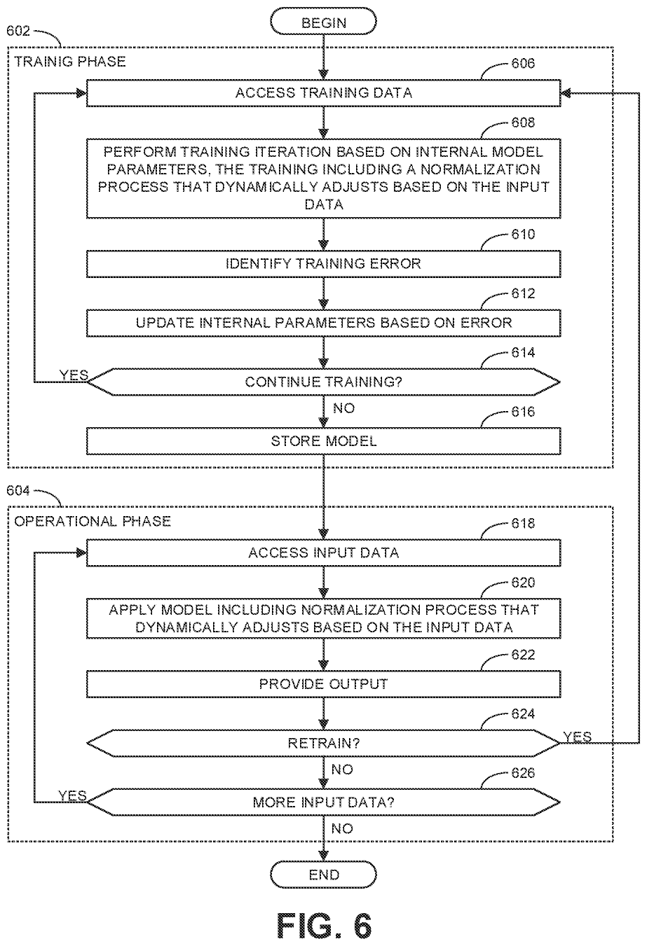

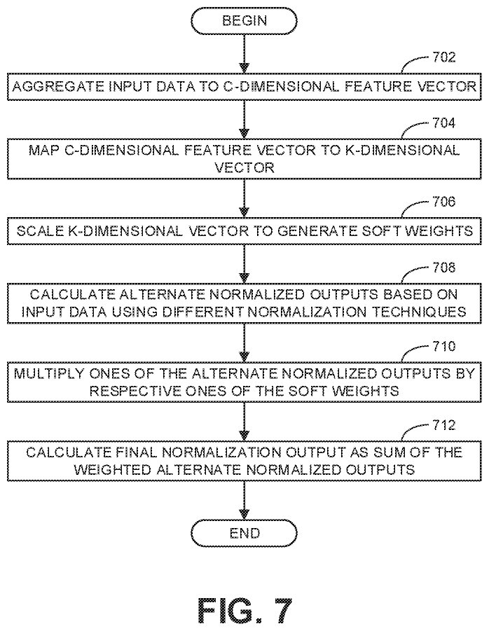

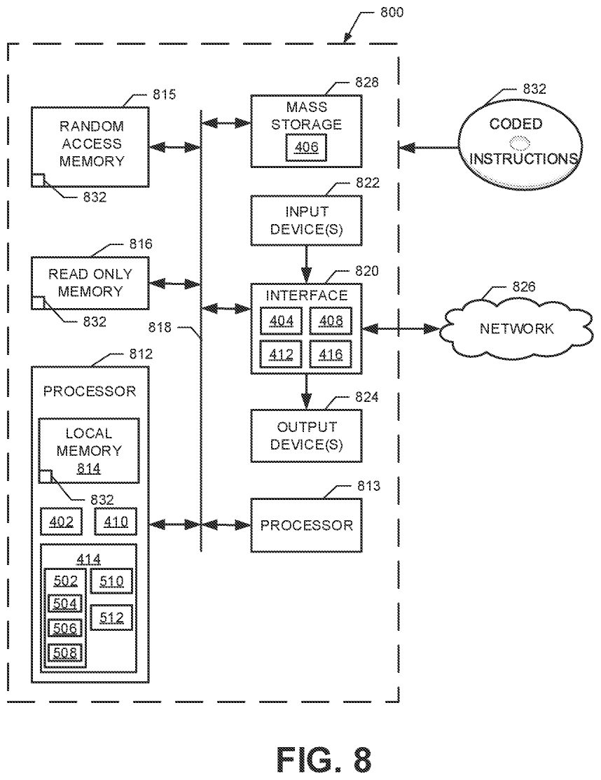

Flowcharts representative of example hardware logic, machine readable instructions, hardware implemented state machines, and/or any combination thereof for implementing the computing system 400 of FIG. 4 is shown in FIGS. 6 and 7. More particularly, FIG. 6 represents an example implementation of the computing system 400 as a whole, while FIG. 7 represents an example implementation of the DSN engine 414 in particular. The machine readable instructions may be one or more executable programs or portion(s) of an executable program for execution by a computer processor and/or processor circuitry, such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowcharts illustrated in FIGS. 6 and 7, many other methods of implementing the example computing system 400 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example processes of FIGS. 6 and 7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 6 is a flowchart representing example machine readable instructions that may be executed by the computer system 400 of FIG. 4 to train and execute a machine learning model that involves the normalization of data under analysis in a dynamic manner based on the input data being analyzed. As represented in the illustrated example, the operation or process flow of a ML/AI system typically involves two phases including a learning/training phase 602 and an operational (e.g., inference) phase 604. In the learning/training phase 602, a training algorithm is used to train a model to operate in accordance with patterns and/or associations based on, for example, training data. In general, the model includes internal parameters that guide how input data is transformed into output data, such as through a series of nodes and connections within the model to transform input data into output data. Among other things, these internal model parameters may define the particular normalization techniques implemented by the DSN engine 414 as well as the process to generate the soft weights 212 that are multiplied with the outputs of the different normalization techniques. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

The example process of FIG. 6 begins at block 606 where the model trainer 410 accesses training data via the training data interface 412. Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent. However, any other training algorithm may additionally or alternatively be used. In examples disclosed herein, training is performed until an acceptable level of error is achieved. Such training is performed using any suitable training data, which may depend on the particular task for which the model is being implemented. At block 608, the example computing system 400 performs a training iteration based on internal model parameters, where the training includes a normalization process that dynamically adjusts based on the input data. The particular process to perform a training iteration may vary depending on the type of machine learning model being trained and/or the particular task(s) for which the model is being implemented. Accordingly, block 608 of FIG. 6 is provided to generally represent the training of any suitable type of machine learning model that involves the normalization of the input data being analyzed. The training may involve any suitable past, present, or future training technique that is capable of incorporating the normalization process flow 200 discussed above and further detailed below in connection with FIG. 7.

Once the training iteration is complete, the example model trainer 410, at block 610, determines an amount of training error. That is the model trainer 410 compares an output of the model following the training iteration with expected outputs defined in the training data. At block 612, the example model trainer updates the internal parameters based on the error. Thereafter, at block 614, the example model trainer 410 determines whether to continue training. In some examples, such determination may be based on an amount of training error (e.g., training is to continue if an amount of error exceeds an error threshold). However, any other approach to determining whether training is to continue may additionally or alternatively be used including, for example, an amount of training iterations performed, an amount of time elapsed since training began, etc. If the model trainer 410 determines that training is to continue (e.g., block 614 returns a result of YES), control returns to block 606 to repeat the process.

If the model trainer 410 determines that training is not to continue (e.g., block 614 returns a result of NO), control advances to block 616 where the model is stored at the model parameter memory 406 of the example computing system 400. In some examples, the model is stored as an executable construct that processes an input and provides an output based on the network of nodes and connections defined in the model. While in examples disclosed herein, the model is stored in the model parameter memory 406, the model may additionally or alternatively be communicated to a model parameter memory of a different computing system via the model communicator 416. The model may then be executed by the model executor 402.

Once trained, the deployed model may be operated in the operational (e.g., inference) phase 604 to process data. In the inference phase, data to be analyzed (e.g., live data) is input to the model, and the model is executed to generate an output. This inference phase can be thought of as the computing system “thinking” to generate the output based on what was learned from the training (e.g., by executing the model to apply the learned patterns and/or associations to the live data).

As represented in FIG. 6, the operational phase 604 begins at block 618 where the example model executor 402 accesses input data via the input interface 404. At block 620, the example model executor 402 (using the example DSN engine 414) applies the model including the normalization process that dynamically adjusts based on the input data. At block 622, the example output interface 408 provides an output of the model. In some examples, the output data may undergo post-processing after it is generated by the AI model to transform the output into a useful result (e.g., a display of data, an instruction to be executed by a machine, etc.).

At block 624, the example model trainer 410 monitors the output of the model to determine whether to attempt re-training of the model. In this manner, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model. In some examples, re-training may occur to adjust or adapt the model to a different task. If re-training is to occur (e.g., block 624 returns a result of YES), control returns to block 606, where the training phase 602 is repeated. If re-training is not to occur (e.g., block 624 returns a result of NO), control advances to block 626 where the example model executor 402 determines whether there is more input data to analyze. If so (e.g., block 626 returns a result of YES), control returns to block 618. Otherwise (e.g., block 626 returns a result of NO), the example process of FIG. 6 ends.

FIG. 7 is a flowchart representing example machine readable instructions that may be executed by the example DSN engine 414 of FIG. 5 as part of the example computing system 400 of FIG. 4 to implement the normalization process flow 200 of FIG. 2 as part of the training iteration in block 608 of FIG. 6 and the model application in block 620 in FIG. 6. In some examples, the example process of FIG. 7 may be implemented multiple times during a single training iteration and/or during a single application of the model. That is, in some examples, the normalization process represented in FIG. 7 is repeated at multiple layers within a neural network model with the output of each layer be re-normalized for the subsequent layer in the model. in a implemented at each layer in a deep neural network train and execute a machine learning model that involves the normalization of data under analysis in a dynamic manner based on the input data being analyzed.

The example process of FIG. 7 begins at block 702 where the example spatial aggregation analyzer 504 aggregates input data to a C-dimensional feature vector (e.g., the C-dimensional feature vector 308 of FIG. 3). As mentioned above, the input data may correspond to the initial input data provided to the model executor 402 and/or model trainer 410 or correspond to a feature map created from the initial input data by a previous layer in the neural network architecture of the machine learning model. The input data may be aggregated in any suitable manner (e.g., max pooling, average pooling, etc.). At block 704, the example mapping analyzer 506 maps the C-dimensional feature vector 308 to a k-dimensional vector (e.g., the k-dimensional vector 310 of FIG. 3). The mapping from the first vector 308 to the second vector 310 may be based on a linear relationship, a non-linear relationship, and/or any other suitable mapping algorithm. At block 706, the example scaling analyzer 508 scales the k-dimensional vector 310 to generate soft weights 212. In some examples, the values in the k-dimensional vector 310 may be used as the soft weights 212 without any scaling. Thus, in some examples, block 706 may be omitted.

At block 708, the example normalization calculator(s) 510 calculate alternate normalized outputs based on the input data using different normalization techniques (e.g., the normalization techniques 204, 206, 208 of FIG. 2). Any past, present, or future normalization technique may be included among the alternate techniques implemented by the example DSN engine 414. At block 710, the example normalized output generator 512 multiplies ones of the alternate normalized outputs (generated at block 708) by respective ones of the soft weights 212 (generated at block 706). In this manner, the contributions of the outputs of the different normalization techniques to the final normalized output are weighted using soft weights determined dynamically based on the input data. This provides for greater flexibility and increased accuracy relative to other known normalization methodologies that are based on fixed internal parameters of the model being trained and/or applied. At block 712, the example normalized output generator 512 calculates the final normalized output as the sum of the weighted alternate normalized outputs. Thereafter, the example process of FIG. 7 ends so that any remaining processes associated with the current layer being executed in a neural network machine learning model and/or subsequent layers in the model may be implemented.

FIG. 8 is a block diagram of an example processor platform 800 structured to execute the instructions of FIGS. 6 and 7 to implement the computing system 400 of FIG. 4 and, more particularly, the DSN engine 414 of FIGS. 4 and 5. The processor platform 800 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, VPUs, AI-specific processors, or controllers from any desired family or manufacturer. The hardware processor 812 may be a semiconductor based (e.g., silicon based) device. In this example, the processor implements the example model executor 402, the example model trainer 410, and the example DSN engine 414 (including the example soft weighting engine 502, the example spatial aggregation analyzer 504, the example mapping analyzer 506, the example scaling analyzer 508, the example normalization calculator(s) 510, and the example normalized output generator 512).

In some examples, the processor platform 800 includes a second processor 813 (e.g., a co-processor). The second processor 813 of the illustrated example is hardware. For example, the second processor 813 can be implemented by one or more integrated circuits, logic circuits, microprocessors, GPUs, DSPs, VPUs, AI-specific processors, or controllers from any desired family or manufacturer. The second processor 813 may be a semiconductor based (e.g., silicon based) device. In some examples, the second processor 813 implements one or more of the example model executor 402, the example model trainer 410, and the example DSN engine 414 (including the example soft weighting engine 502, the example spatial aggregation analyzer 504, the example mapping analyzer 506, the example scaling analyzer 508, the example normalization calculator(s) 510, and the example normalized output generator 512), while the main processor 812 implements different ones of the components of the computing system 400 detailed in FIGS. 4 and 5. In some examples, the main processor 812 and the second processor 813 are included in a single system on a chip (SoC).

The processor 812 of the illustrated example includes a local memory 814 (e.g., a cache). The processor 812 of the illustrated example is in communication with a main memory including a volatile memory 815 and a non-volatile memory 816 via a bus 818. The volatile memory 815 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 815, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system. In this example, the interface circuit 820 implements the example input interface 404, the example output interface 408, the example training data interface 412, the example model communicator 416.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives. In this example, the mass storage devices 828 implements the example model parameter memory 406.

The machine executable instructions 832 of FIGS. 6 and 7 may be stored in the mass storage device 828, in the volatile memory 815, in the non-volatile memory 816, and/or on a removable non-transitory computer readable storage medium such as a CD or DVD.

From the foregoing, it will be appreciated that example methods, apparatus and articles of manufacture have been disclosed that provide an example normalization engine that is generally applicable to different circumstances by incorporating multiple different normalization techniques that can be dynamically combined in different ways as determined from the unique feature characteristics of the input data being analyzed. The ability to dynamically adjust the contribution of different normalization techniques also significantly improves the accuracy of associated neural networks with negligible increases in computational demand. The general applicability of example normalization engines disclosed herein enable such engines to be deployed on different edge/cloud devices for supporting existing and/or emerging artificial intelligence applications scenarios associated with a large variety of tasks including computer vision, natural language processing, speech recognition, image classification, etc. Furthermore, example normalization engines disclosed herein are also suitable for large-scale parallel training systems that depend upon well-designed, synced normalization techniques to address concerns of gradient vanishing and/or explosion problems while reducing power consumption by accelerating training convergence when batch size becomes relatively large (e.g., 8192). In particular, these requirements are readily satisfied by example normalization engines disclosed herein because the engines are designed to adaptively combine different normalization techniques for improved accuracy at negligible extra computational costs. In other words, the disclosed methods, apparatus, and articles of manufacture improve the efficiency of using a computing device by enabling different normalization techniques to be used in combination for improved accuracy and increased adaptability to different deep learning tasks and/or network architectures. The disclosed methods, apparatus and articles of manufacture are accordingly directed to one or more improvement(s) in the functioning of a computer.

Example 1 includes an apparatus for use with a machine learning model, the apparatus comprising at least one normalization calculator to generate a plurality of alternate normalized outputs associated with input data for the machine learning model, different ones of the alternate normalized outputs based on different normalization techniques, a soft weighting engine to generate a plurality of weights based on the input data, and a normalized output generator to generate a final normalized output based on the plurality of alternate normalized outputs and the plurality of weights.

Example 2 includes the apparatus of example 1, wherein the normalized output generator is to generate the final normalized output as a sum of a product of ones of the plurality of weights and respective ones of the plurality of alternate normalized outputs.

Example 3 includes the apparatus of any one of examples 1 or 2, wherein the input data is first input data and the plurality of weights is a first plurality of weights, the soft weighting engine to generate a second plurality of weights based on second input data different than the first input data, the second plurality of weights different than the first plurality of weights due to distinctions between the first input data and the second input data.

Example 4 includes the apparatus of any one of examples 1-3, wherein the soft weighting engine includes an aggregation analyzer to aggregate the input data into a first vector, and a mapping analyzer to map the first vector to a second vector, a number of elements in the second vector being the same as a number of the different normalization techniques, the plurality of weights based on values in the second vector.

Example 5 includes the apparatus of example 4, wherein the soft weighting engine includes a scaling analyzer to scale the values in the second vector.

Example 6 includes the apparatus of any one of examples 1-5, wherein the machine learning model is a neural network with multiple layers.

Example 7 includes the apparatus of example 6, wherein the input data is first input data for a first layer in the neural network and the plurality of weights is a first plurality of weights, the soft weighting engine to generate a second plurality of weights based on second input data for a second layer in the neural network, the second input data based on the final normalized output.

Example 8 includes the apparatus of example 7, wherein the plurality of alternate normalized outputs is a first plurality of alternate normalized outputs associated with the first layer in the neural network and the final normalized output is a first final normalized output associated with the first layer in the neural network, the at least one normalization calculator to generate a second plurality of alternate normalized outputs associated with second input data, the normalized output generator to generate a second final normalized output based on the second plurality of alternate normalized outputs and the second plurality of weights.

Example 9 includes the apparatus of any one of examples 1-8, wherein the soft weighting engine is to generate the plurality of weights independent of the alternate normalized outputs.

Example 10 includes the apparatus of any one of examples 1-9, wherein the plurality of weights corresponds to soft weights with values that may differ along a range from 0 to 1.

Example 11 includes at least one non-transitory computer readable medium comprising instructions that, when executed, cause at least one processor to at least generate a plurality of alternate normalized outputs associated with input data for a machine learning model, different ones of the alternate normalized outputs based on different normalization techniques, generate a plurality of weights based on the input data, and generate a final normalized output based on the plurality of alternate normalized outputs and the plurality of weights.

Example 12 includes the at least one non-transitory computer readable medium of example 11, wherein the instructions further cause the at least one processor to generate the final normalized output as a sum of a product of ones of the plurality of weights and respective ones of the plurality of alternate normalized outputs.

Example 13 includes the at least one non-transitory computer readable medium of any one of examples 11 or 12, wherein the input data is first input data and the plurality of weights is a first plurality of weights, the instructions to further cause the at least one processor to generate a second plurality of weights based on second input data different than the first input data, the second plurality of weights different than the first plurality of weights due to distinctions between the first input data and the second input data.

Example 14 includes the at least one non-transitory computer readable medium of any one of examples 11-13, wherein the instructions further cause the at least one processor to aggregate the input data into a first vector, and map the first vector to a second vector, a number of elements in the second vector being the same as a number of the different normalization techniques, the plurality of weights based on values in the second vector.

Example 15 includes the at least one non-transitory computer readable medium of example 14, wherein the instructions further cause the at least one processor to scale the values in the second vector.

Example 16 includes the at least one non-transitory computer readable medium of any one of examples 11-15, wherein the machine learning model is a neural network with multiple layers.

Example 17 includes the at least one non-transitory computer readable medium of example 16, wherein the input data is first input data for a first layer in the neural network and the plurality of weights is a first plurality of weights, the instructions to further cause the at least one processor to generate a second plurality of weights based on second input data for a second layer in the neural network, the second input data based on the final normalized output.

Example 18 includes the at least one non-transitory computer readable medium of example 17, wherein the plurality of alternate normalized outputs is a first plurality of alternate normalized outputs associated with the first layer in the neural network and the final normalized output is a first final normalized output associated with the first layer in the neural network, the instructions to further cause the at least one processor to generate a second plurality of alternate normalized outputs associated with second input data, and generate a second final normalized output based on the second plurality of alternate normalized outputs and the second plurality of weights.

Example 19 includes the at least one non-transitory computer readable medium of any one of examples 11-18, wherein the instructions further cause the at least one processor to generate the plurality of weights independent of the alternate normalized outputs.

Example 20 includes the at least one non-transitory computer readable medium of any one of examples 11-19, wherein the plurality of weights corresponds to soft weights with values that may differ along a range from 0 to 1.

Example 21 includes a method for using a machine learning model, the method comprising generating a plurality of alternate normalized outputs associated with input data for the machine learning model, different ones of the alternate normalized outputs based on different normalization techniques, generating a plurality of weights based on the input data, and generating a final normalized output based on the plurality of alternate normalized outputs and the plurality of weights.

Example 22 includes the method of example 21, further including generating the final normalized output as a sum of a product of ones of the plurality of weights and respective ones of the plurality of alternate normalized outputs.

Example 23 includes the method of any one of examples 21 or 22, wherein the input data is first input data and the plurality of weights is a first plurality of weights, the method further including generating a second plurality of weights based on second input data different than the first input data, the second plurality of weights different than the first plurality of weights due to distinctions between the first input data and the second input data.

Example 24 includes the method of any one of examples 21-23, further including aggregating the input data into a first vector, and mapping the first vector to a second vector, a number of elements in the second vector being the same as a number of the different normalization techniques, the plurality of weights based on values in the second vector.

Example 25 includes the method of example 24, further including scaling the values in the second vector.

Example 26 includes the method of any one of examples 21-25, wherein the machine learning model is a neural network with multiple layers.

Example 27 includes the method of example 26, wherein the input data is first input data for a first layer in the neural network and the plurality of weights is a first plurality of weights, the method further including generating a second plurality of weights based on second input data for a second layer in the neural network, the second input data based on the final normalized output.

Example 28 includes the method of example 27, wherein the plurality of alternate normalized outputs is a first plurality of alternate normalized outputs associated with the first layer in the neural network and the final normalized output is a first final normalized output associated with the first layer in the neural network, the method further including generating a second plurality of alternate normalized outputs associated with second input data, and generating a second final normalized output based on the second plurality of alternate normalized outputs and the second plurality of weights.

Example 29 includes the method of any one of examples 21-28, further including generating the plurality of weights independent of the alternate normalized outputs.

Example 30 includes the method of any one of examples 21-29, wherein the plurality of weights corresponds to soft weights with values that may differ along a range from 0 to 1.

Example 31 includes an apparatus for use with a machine learning model, the apparatus comprising means for generating a plurality of alternate normalized outputs associated with input data for the machine learning model, different ones of the alternate normalized outputs based on different normalization techniques, means for generating a plurality of weights based on the input data, and means for generating a final normalized output based on the plurality of alternate normalized outputs and the plurality of weights.

Example 32 includes the apparatus of example 31, wherein the final normalized output generating means is to generate the final normalized output as a sum of a product of ones of the plurality of weights and respective ones of the plurality of alternate normalized outputs.

Example 33 includes the apparatus of any one of examples 31 or 32, wherein the input data is first input data and the plurality of weights is a first plurality of weights, the weights generating means to generate a second plurality of weights based on second input data different than the first input data, the second plurality of weights different than the first plurality of weights due to distinctions between the first input data and the second input data.

Example 34 includes the apparatus of any one of examples 31-33, wherein the weights generating means includes means for aggregating the input data into a first vector, and means for mapping the first vector to a second vector, a number of elements in the second vector being the same as a number of the different normalization techniques, the plurality of weights based on values in the second vector.

Example 35 includes the apparatus of example 34, wherein the weights generating means includes means for scaling the values in the second vector.

Example 36 includes the apparatus of any one of examples 31-35, wherein the machine learning model is a neural network with multiple layers.

Example 37 includes the apparatus of example 36, wherein the input data is first input data for a first layer in the neural network and the plurality of weights is a first plurality of weights, the weights generating means is to generate a second plurality of weights based on second input data for a second layer in the neural network, the second input data based on the final normalized output.

Example 38 includes the apparatus of example 37, wherein the plurality of alternate normalized outputs is a first plurality of alternate normalized outputs associated with the first layer in the neural network and the final normalized output is a first final normalized output associated with the first layer in the neural network, the alternate normalized outputs generating means to generate a second plurality of alternate normalized outputs associated with second input data, the final normalized output generating means to generate a second final normalized output based on the second plurality of alternate normalized outputs and the second plurality of weights.

Example 39 includes the apparatus of any one of examples 31-38, wherein the weights generating means is to generate the plurality of weights independent of the alternate normalized outputs.

Example 40 includes the apparatus of any one of examples 31-39, wherein the plurality of weights corresponds to soft weights with values that may differ along a range from 0 to 1.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus for use with a machine learning model, the apparatus comprising:
at least one normalization calculator to generate a plurality of alternate normalized outputs associated with input data for the machine learning model, different ones of the alternate normalized outputs based on different normalization techniques;
a soft weighting engine to generate a plurality of weights based on the input data; and
a normalized output generator to generate a final normalized output based on the plurality of alternate normalized outputs and the plurality of weights.

2. The apparatus of claim 1, wherein the normalized output generator is to generate the final normalized output as a sum of a product of ones of the plurality of weights and respective ones of the plurality of alternate normalized outputs.

3. The apparatus of claim 1, wherein the input data is first input data and the plurality of weights is a first plurality of weights, the soft weighting engine to generate a second plurality of weights based on second input data different than the first input data, the second plurality of weights different than the first plurality of weights due to distinctions between the first input data and the second input data.

4. The apparatus of claim 1, wherein the soft weighting engine includes:
an aggregation analyzer to aggregate the input data into a first vector; and
a mapping analyzer to map the first vector to a second vector, a number of elements in the second vector being the same as a number of the different normalization techniques, the plurality of weights based on values in the second vector.

5. The apparatus of claim 4, wherein the soft weighting engine includes a scaling analyzer to scale the values in the second vector.

6. The apparatus of claim 1, wherein the machine learning model is a neural network with multiple layers.

7. The apparatus of claim 6, wherein the input data is first input data for a first layer in the neural network and the plurality of weights is a first plurality of weights, the soft weighting engine to generate a second plurality of weights based on second input data for a second layer in the neural network, the second input data based on the final normalized output.

8. The apparatus of claim 7, wherein the plurality of alternate normalized outputs is a first plurality of alternate normalized outputs associated with the first layer in the neural network and the final normalized output is a first final normalized output associated with the first layer in the neural network, the at least one normalization calculator to generate a second plurality of alternate normalized outputs associated with second input data, the normalized output generator to generate a second final normalized output based on the second plurality of alternate normalized outputs and the second plurality of weights.

9. The apparatus of claim 1, wherein the soft weighting engine is to generate the plurality of weights independent of the alternate normalized outputs.

10. The apparatus of claim 1, wherein the plurality of weights corresponds to soft weights with values that may differ along a range from 0 to 1.

11. At least one non-transitory computer readable medium comprising instructions that, when executed, cause at least one processor to at least:
generate a plurality of alternate normalized outputs associated with input data for a machine learning model, different ones of the alternate normalized outputs based on different normalization techniques;
generate a plurality of weights based on the input data; and
generate a final normalized output based on the plurality of alternate normalized outputs and the plurality of weights.

12. The at least one non-transitory computer readable medium of claim 11, wherein the instructions further cause the at least one processor to generate the final normalized output as a sum of a product of ones of the plurality of weights and respective ones of the plurality of alternate normalized outputs.

13. The at least one non-transitory computer readable medium of claim 11, wherein the input data is first input data and the plurality of weights is a first plurality of weights, the instructions to further cause the at least one processor to generate a second plurality of weights based on second input data different than the first input data, the second plurality of weights different than the first plurality of weights due to distinctions between the first input data and the second input data.

14. The at least one non-transitory computer readable medium of claim 11, wherein the instructions further cause the at least one processor to:
aggregate the input data into a first vector; and
map the first vector to a second vector, a number of elements in the second vector being the same as a number of the different normalization techniques, the plurality of weights based on values in the second vector.

15. The at least one non-transitory computer readable medium of claim 14, wherein the instructions further cause the at least one processor to scale the values in the second vector.

16. The at least one non-transitory computer readable medium of claim 11, wherein the machine learning model is a neural network with multiple layers.

17. The at least one non-transitory computer readable medium of claim 16, wherein the input data is first input data for a first layer in the neural network and the plurality of weights is a first plurality of weights, the instructions to further cause the at least one processor to generate a second plurality of weights based on second input data for a second layer in the neural network, the second input data based on the final normalized output.

18. The at least one non-transitory computer readable medium of claim 17, wherein the plurality of alternate normalized outputs is a first plurality of alternate normalized outputs associated with the first layer in the neural network and the final normalized output is a first final normalized output associated with the first layer in the neural network, the instructions to further cause the at least one processor to:
generate a second plurality of alternate normalized outputs associated with second input data; and
generate a second final normalized output based on the second plurality of alternate normalized outputs and the second plurality of weights.

19. A method for using a machine learning model, the method comprising:
generating a plurality of alternate normalized outputs associated with input data for the machine learning model, different ones of the alternate normalized outputs based on different normalization techniques;
generating a plurality of weights based on the input data; and
generating a final normalized output based on the plurality of alternate normalized outputs and the plurality of weights.

20. The method of claim 19, further including generating the final normalized output as a sum of a product of ones of the plurality of weights and respective ones of the plurality of alternate normalized outputs.

21. The method of claim 19, wherein the input data is first input data and the plurality of weights is a first plurality of weights, the method further including generating a second plurality of weights based on second input data different than the first input data, the second plurality of weights different than the first plurality of weights due to distinctions between the first input data and the second input data.

22. The method of claim 19, further including:
aggregating the input data into a first vector; and
mapping the first vector to a second vector, a number of elements in the second vector being the same as a number of the different normalization techniques, the plurality of weights based on values in the second vector.

23. An apparatus for use with a machine learning model, the apparatus comprising:
means for generating a plurality of alternate normalized outputs associated with input data for the machine learning model, different ones of the alternate normalized outputs based on different normalization techniques;
means for generating a plurality of weights based on the input data; and
means for generating a final normalized output based on the plurality of alternate normalized outputs and the plurality of weights.

24. The apparatus of claim 23, wherein the final normalized output generating means is to generate the final normalized output as a sum of a product of ones of the plurality of weights and respective ones of the plurality of alternate normalized outputs.

25. The apparatus of claim 23, wherein the input data is first input data and the plurality of weights is a first plurality of weights, the weights generating means to generate a second plurality of weights based on second input data different than the first input data, the second plurality of weights different than the first plurality of weights due to distinctions between the first input data and the second input data.
